(19) United States
(12) Patent Application Publication
(10) Pub. No.: US 2013/0231955 A1
(43) Pub. Date: Sep. 5, 2013

(54) Integrated, Multilevel Medical Services

(71) Applicant: HEALTH E 4 LIFE LIMITED, Douglas (ZA)

(72) Inventors: Cornelius Meyer DE VILLIERS, Claremont (ZA); Dirk Jacobus VAN DER MERWE, Welgemoed (ZA)

(73) Assignee: HEALTH E 4 LIFE LIMITED, Douglas (ZA)

(21) Appl. No.: 13/711,568

(22) Filed: Dec. 11, 2012

Related U.S. Application Data
(63) Continuation-in-part of application No. 13/080,919, filed on Apr. 6, 2011, now abandoned.
Application No. 13/080,919 is a continuation of application No. 10/559,673, filed on Dec. 18, 2006, now abandoned.

(30) Foreign Application Priority Data
Jun. 6, 2003 (ZA) 2003/4426

(51) Int. Cl. G06F 19/00

(52) U.S. Cl. CPC G06F 19/322
USPC 705/3

(57) ABSTRACT

A method of performing a diagnosis by acquiring data includes receiving an indication of a diagnostic hypothesis, sequentially outputting questions of a structured set of questions related to the diagnostic hypothesis for the indication, receiving a reply corresponding to each question that is output, for each question that is output, generating a respective set of data pertaining to the question and the corresponding reply for the question and formatting the respective set of data into a plurality of record sets for the question, and storing the plurality of record sets for each question within a database in an entry associated with the subject and the diagnostic hypothesis to which the question is related. The questions of the structured set of questions for each indication are dynamically selected for outputting based on the corresponding replies received for the questions.

### CROSS REFERENCE TO RELATED APPLICATIONS

This application is a continuation-in-part of U.S. application Ser. No. 13/080,919, filed Apr. 6, 2012, which is a continuation of U.S. application Ser. No. 10/559,673, filed Dec. 18, 2006, which is a 371 application of PCT/IB2004/050844, filed Jun. 5, 2004, all of said applications incorporated herein by reference.

### BACKGROUND OF THE INVENTION

Exemplary embodiments of the present invention relate to medical services. More specifically, exemplary embodiments relate to methods and apparatuses for providing an integrated, multilevel medical service system that provides a secure network-based electronic health record maintenance system, a diagnostic assistance mechanism, and a treatment management mechanism.

Worldwide medicine, like law and engineering, is a profession regulated by governing bodies (for example, the British Medical Council) and only qualified doctors are allowed to register and practice in that particular country. Every patient that consults a doctor enters into a legal doctor-patient relationship whereby the doctor takes a detailed history and makes a diagnosis in order to treat the patient. When medical doctors examine patients, they normally do so by following a routine which they have developed through experience. The routines of various doctors thus vary depending upon, for example, the area of medicine in which they have specialized, the type of experience they have gained, and the country in which they have been trained.

After each examination of a patient, a doctor should write a report on his findings and diagnosis of the patient. This enables the doctor to record a history of the medical problems of a patient. Applicable governing bodies may require that all records be kept for a specified period of time (for example, 5 years) for future reference. Moreover, inadequately documented medical charts can lead civil and criminal liability for medical practitioners and/or hospitals.

If the patient should change to a second doctor, or if the patient is referred to a second doctor for specialist treatment, then it is preferable that the second doctor knows the medical history of the patient. Currently, however, there is no mechanism by which a patient's medical history can be reliably stored or transferred to a second doctor. Thus, doctor often expend a certain amount of time re-diagnosing the patient before treating the patient, and there is often redundancy in the tests and evaluations that are conducted. This is inefficient and in some circumstances may result in an incorrect diagnosis of a patient's medical condition.

### SUMMARY OF THE INVENTION

Exemplary embodiments of the present invention are related to a method for performing a diagnosis by acquiring data. The method includes receiving one or more indications of a diagnostic hypothesis regarding a subject and adding each indication to a queue upon the indication being received, and sequentially removing each indication from the queue and processing the indication. Processing an indication removed from the queue includes sequentially outputting questions of a structured set of questions related to the diagnostic hypothesis for the indication, receiving a reply corresponding to each question of the set of questions that is output, and, for each question of the set of questions that is output, generating a respective set of data pertaining to the question and the corresponding reply for the question and formatting the respective set of data into a plurality of record sets for the question. The method further includes storing the plurality of record sets for each question within a database in an entry associated with the subject and the diagnostic hypothesis to which the question is related. The plurality of record sets for each question includes first, second, and third record sets. The first record set for each question includes a first unique number associated with the subject, a second unique number associated with a person making the diagnostic hypothesis to which the question is related, a third unique number associated with the question, and a fourth number generated based on the corresponding reply for the question. The second record set for each question is generated in association with the first record set for the question, and the second record set includes a question code associated with the third unique number of the first record set for the question; and a statistical weight associated with the third unique number of the first record set for the question for applying to the fourth number of the first record set for the question. The third record set for each question is generated in association with the second record set for the question, the third record set including a description reference of the question code of the second record set for the question. The questions of the structured set of questions for each indication are dynamically selected for outputting based on the corresponding replies received for the questions.

Exemplary embodiments of the present invention that are related to computer program products and data processing systems corresponding to the above-summarized method are also described and claimed herein.

The above-described and other features and advantages realized through the techniques of the present disclosure will be better appreciated and understood with reference to the following detailed description, drawings, and appended claims. Additional features and advantages are realized through the techniques of the present invention. Other embodiments and aspects of the invention are described in detail herein and are considered a part of the claimed invention.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a schematic diagram illustrating an exemplary embodiment of a distributed medical service system in accordance with the present invention;

FIG. 2a is an example of a first code set format used for storing and transferring health and medical data in exemplary embodiments of the present invention;

FIG. 2b is an example of a second code set format used for storing and transferring health and medical data in exemplary embodiments of the present invention;

FIG. 2c is an example of a third code set format used for storing and transferring health and medical data in exemplary embodiments of the present invention;

FIG. 2d is an example of a fourth code set format used for storing and transferring health and medical data in exemplary embodiments of the present invention;

FIG. 3 is a block diagram illustrating an exemplary embodiment of a patient management service in accordance with the present invention;

FIG. 4 is a flowchart illustrating an exemplary embodiment of a process for conducting a preliminary diagnostic session in accordance with the present invention;

FIG. 5 is a flowchart illustrating an exemplary embodiment of a process for conducting a professional diagnostic examination in accordance with the present invention;

FIG. 6 is a block diagram of an exemplary computer system 600 that can be used for implementing exemplary embodiments of the present invention;

FIGS. 7a and 7b are illustrations of screenshots of example graphical user interfaces (GUIs) implemented by client applications in accordance with exemplary embodiments of the present invention; and

FIGS. 8a and 8b are flowcharts illustrating a non-limiting example of a process performed by a treatment management component implemented in accordance with exemplary embodiments of the present invention to guide a medical practitioner in monitoring and responding to the progress of patient with regard to a care plan generated for treatment of the patient.

The detailed description explains exemplary embodiments of the present invention, together with advantages and features, by way of example with reference to the drawings, in which similar numbers refer to similar parts throughout the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered to be within the scope of the claimed invention.

### DETAILED DESCRIPTION

While the specification concludes with claims defining the features of the invention that are regarded as novel, it is believed that the invention will be better understood from a consideration of the description of exemplary embodiments in conjunction with drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form, and it will be apparent to those skilled in the art that the present invention may be practiced without these specific details. Further, the terms and phrases used herein are not intended to be limiting but rather to provide an understandable description of the invention.

Exemplary embodiments of an integrated, multilevel medical service system in accordance with the present invention will now be described with reference to the drawings. Exemplary embodiments of the present invention may be implemented to enable patients, doctors, nurses, etc. to access and to generate data in a standard format for storage in a secure network-based electronic health record maintenance system storing patient data in respective health records for patients that can include, for example, patient identification and profile information, diagnostic information pertaining to a diagnosis of a medical condition for the patient including diagnostic results and results of clinical tests, reference and explanatory information related to the diagnostic information, treatment information including medical services and costs regarding a diagnosed medical condition, and/or account information regarding accounts the patient may use to pay for medical service costs. Exemplary embodiments may be further implemented to utilize such a network-based electronic health record maintenance system to provide services for patients and medical practitioners such as network-based diagnostic assistance mechanisms network-based treatment management assistance mechanisms.

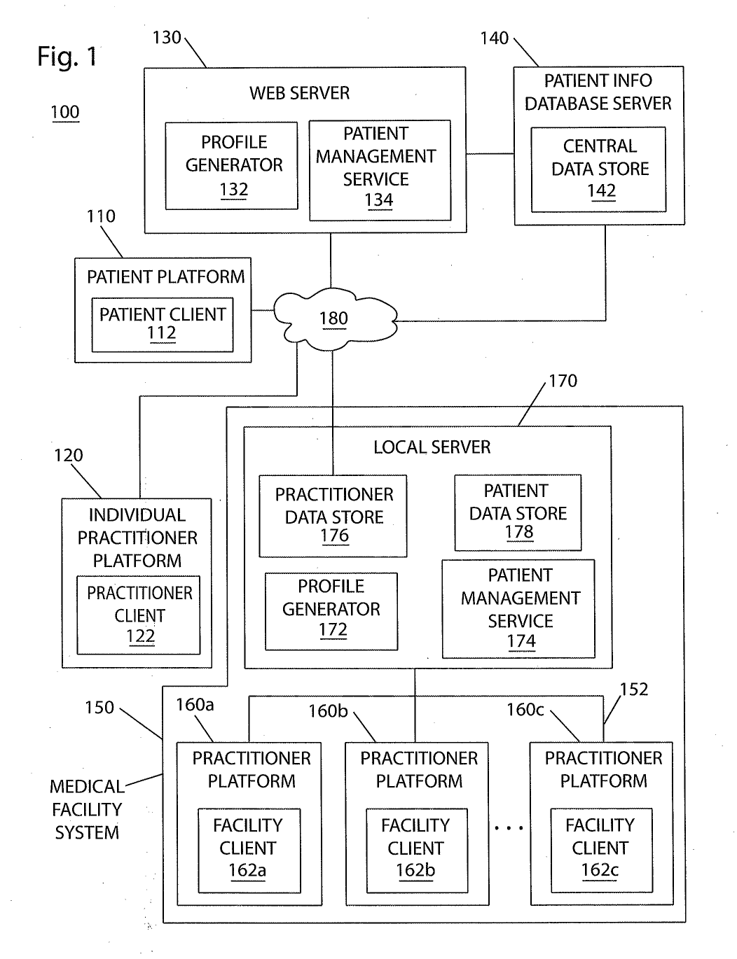

Referring now to FIG. 1, a schematic diagram illustrating an exemplary embodiment of a distributed medical service system 100 in accordance with the present invention is provided. It should of course be understood that FIG. 1 is intended as an example, not as an architectural limitation for different embodiments of the present invention, and therefore, the particular elements depicted in FIG. 1 should not be considered limiting with regard to the environments within which exemplary embodiments of the present invention may be implemented. In the exemplary embodiment illustrated in FIG. 1, system 100 generally includes a patient computing platform 110, an individual practitioner computing platform 120, a web server 130, a patient information database server 140, and a medical facility system 150 that includes a plurality of practitioner computing platforms 160a-160n in communication with a local server 170 over a local communications network 152. Patient platform 110 is a computer device to which one or more persons receiving or seeking to receive medical treatment, or their human agents (for example, personal representatives and assistants), have access. Practitioner platforms 120 and 160a-160n are a computer devices to which one or more medical professionals, or their human agents (for example, secretaries and assistants), have access.

As further illustrated in FIG. 1, patient computing platform 110, individual practitioner computing platform 120, web server 130, and local server 170 are each connected to a communications network 180. Network 180 can facilitate communications between web server 130 and computing platforms 110 and 120 by any suitable wired (including optical fiber), wireless technology, or any suitable combination thereof, including, but not limited to, personal area networks (PANs), local area networks (LANs), wireless networks, wide-area networks (WAN), the Internet (a network of heterogeneous networks using the Internet Protocol, IP), and virtual private networks, and the network may also utilize any suitable hardware technology to connect devices such as, for example, optical fiber, Ethernet, ISDN (Integrated Services Digital Network), T-1 or T-3 link, FDDI (Fiber Distributed Data Network), cable or wireless LMDS network, Wireless LAN, Wireless PAN (for example, IrDA, Bluetooth, Wireless USB, Z-Wave and ZigBee), HomePNA, Power line communication, or telephone line network. Such a network connection can include intranets, extranets, and the Internet, and may contain any number of network infrastructure elements including routers, switches, gateways, etc., and can comprise a circuit switched network, such as the Public Service Telephone Network (PSTN), a packet switched network, such as the global Internet, a private WAN or LAN, a telecommunications network, a broadcast network, or a point-to-point network. Similarly, local network 152 can facilitate communications between local server 170 and practitioner platforms 160a-160n by any suitable wired and/or wireless technology As further illustrated in FIG. 1, network 180 can also facilitate communications between local server 170 and computing platforms 110 and 120, and between database server 140 and local server 170.

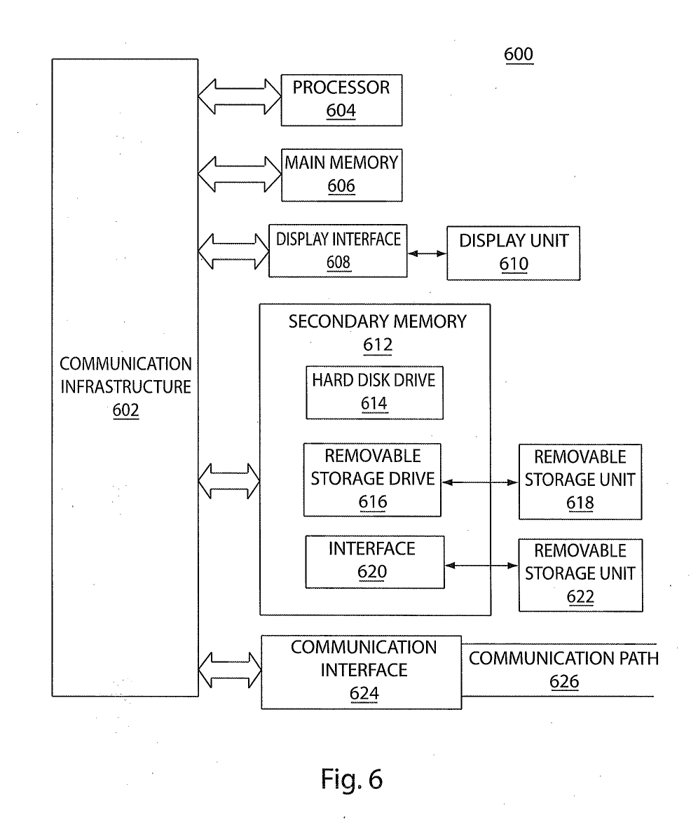

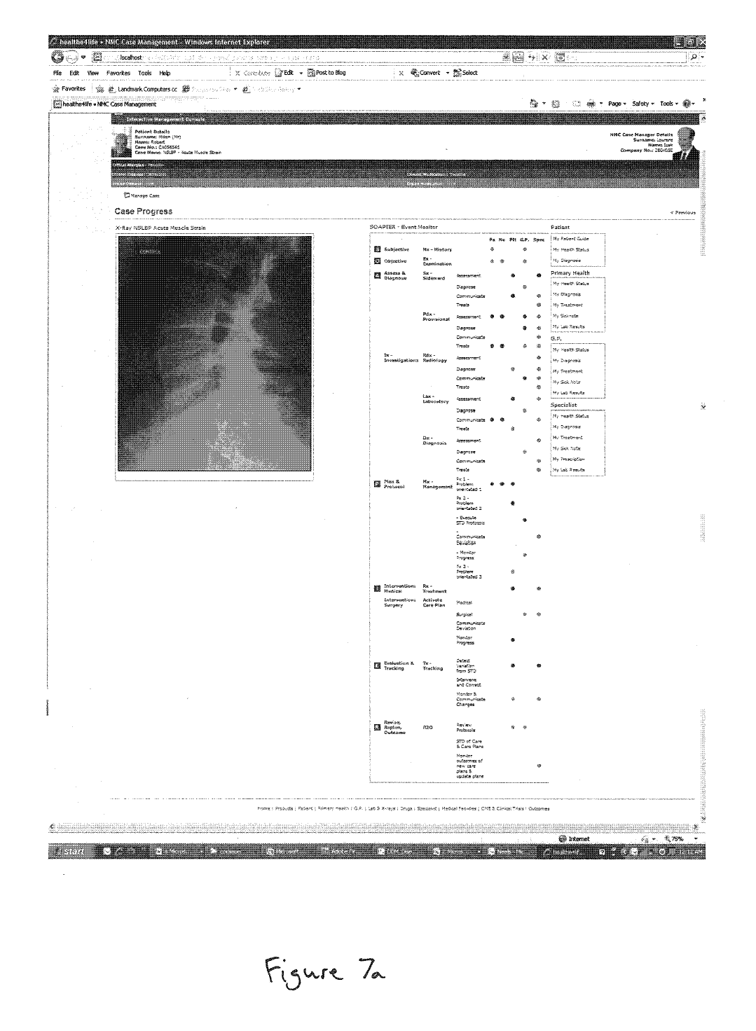

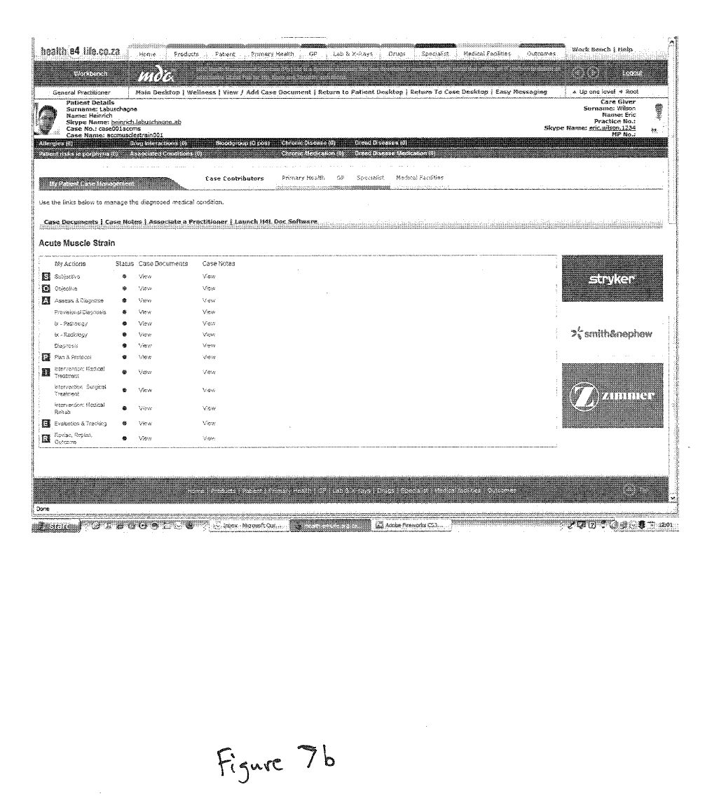

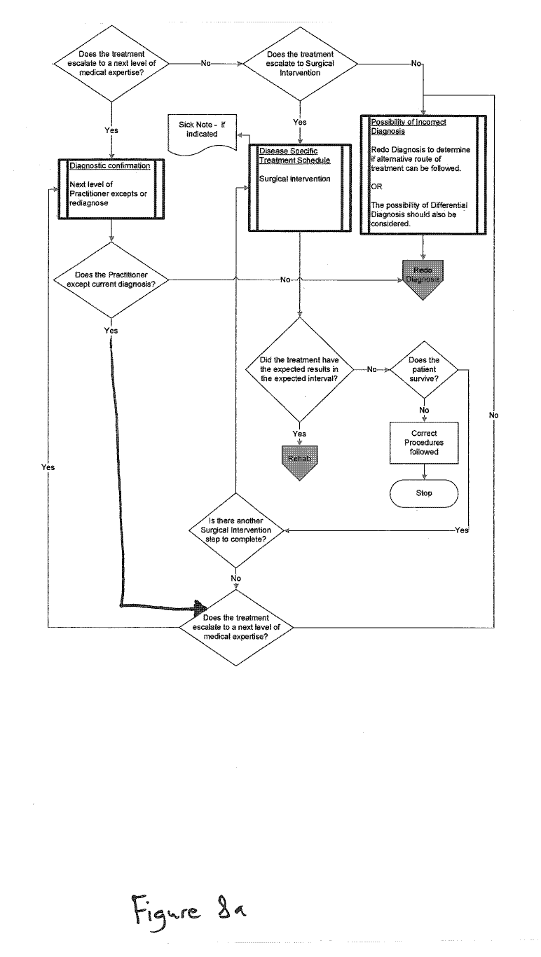

In exemplary embodiments, the computer systems of computing platforms 110, 120, and 160a-160n can be any of a wide range of suitable computing devices such as one or more workstations, desktop computers, laptops, or other personal computers (PCs) (for example, IBM or compatible PC workstations running the MICROSOFT WINDOWS operating system or LINUX OS, MACINTOSH computers running the MAC OSX operating system, or equivalent), non-traditional-computer digital devices such as Personal Digital Assistants (PDAs) and other handheld or portable electronic devices, smart phones tablet PCs, game consoles, home theater PCs, desktop replacement computers, and the like, or any other suitable information processing devices. In other exemplary embodiments, the computer systems of one or more of computing platforms 110, 120, and 160a-160n, web server 130, database server 140, and local server 170 can be a server system (for example, SUN ULTRA workstations running the SUN operating system, IBM RS/6000 workstations and servers running the AIX operating system, or an IBM zSeries eServer running z/OS, z/VM or LINUX OS). An exemplary computer system for computing platforms 110, 120, and 160a-160n is described in greater detail below with reference to FIG. 6.

For purposes of illustration, a single patient platform 110 and a single practitioner platform 120 are shown in FIG. 1. In other exemplary embodiments, more than one patient platform 110 and more than one individual practitioner platform 120 may be connected to network 180. Likewise, more or fewer practitioner platforms may be connected to local network 152 than in the exemplary embodiment illustrated in FIG. 1. While the exemplary embodiment illustrated in FIG. 1 depicts web server 130, database server 140, and local server 170 as individual physical devices, the applications provided by these servers, or various combinations of these applications, may actually be server applications running on separate physical devices.

In exemplary system 100, patient information database server 140 is implemented to provide, as will be described in greater detail below, database services to web server 130 and local server 170 that are accessed at a front-end by the web server and the local server. Database server 170 each be implemented in the form of hardware and/or software. As illustrated in FIG. 1, database server 140 provides a central data store 142, which stores information utilized in providing the services offered by web server 130 such as, for example, patient-indexed electronic health records. As used herein, the term “data store” refers to any suitable memory device that may be used for storing data, including manual files, machine-readable files, and databases.

As will be described in greater detail below, each patient-indexed electronic health record within central data store 142 stores accumulated medical information for a respective patient in a standard format of code sets that is utilized for data storage and communication in conjunction with a diagnostic guidance service and a treatment management service implemented within exemplary system 100 in diagnosing medical conditions the patient may have and in implementing treatment protocols or care plans for the patient based on the determined medical conditions. Patient information database server 140 is configured in conjunction with the components of system 100 to allow for the medical information in the electronic health record for a patient that is generated throughout the course of treatment for the patient to be securely and remotely stored, accessed, analyzed, and updated in a structured, universal protocol by all authorized medical practitioners and other consultants and the like providing care or services for the patient during treatment. Patient information database server 140 is also configured in conjunction with the components of system 100 to allow each patient to control access to his or her electronic health record and the data stored therein.

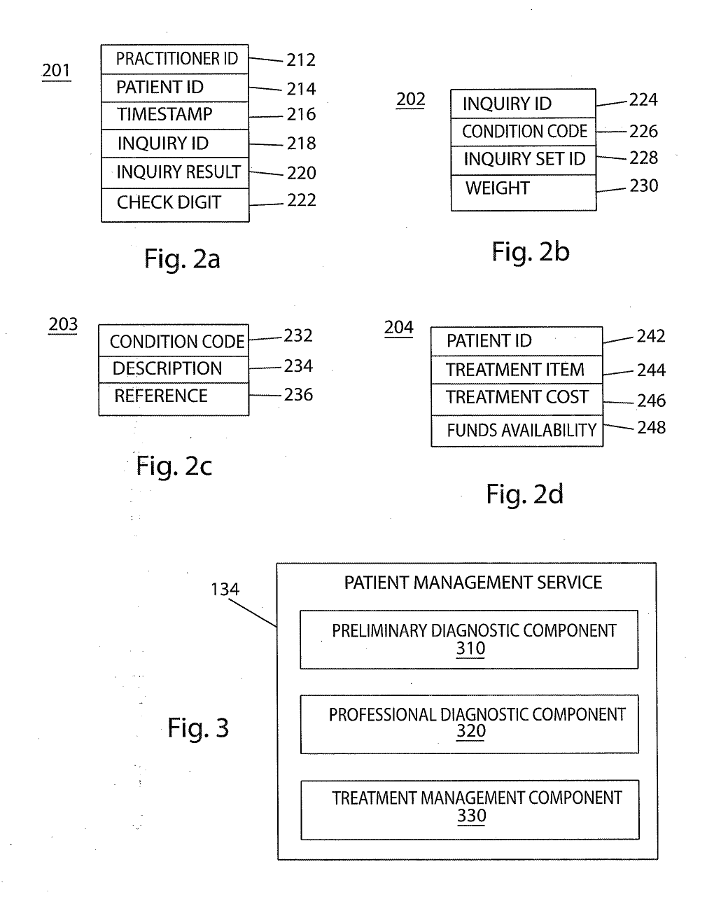

Referring now to FIGS. 2a-2d, four exemplary code set formats 201-204 that may be utilized for transferring health and medical information and storing accumulated health and medical information in electronic health records within central data store 142 are provided. While each code set format is described below in terms of particular fields for corresponding information that are included within the code set format, it should of course be appreciated that exemplary system 100 can employ data structures having additional fields with other relevant information, or fewer fields, in alternative exemplary embodiments

The first code set format 201 is for storing information regarding particular diagnostic inquiries that have been performed upon or asked of corresponding patients. As illustrated in FIG. 2a, each first code set includes six fields: a practitioner ID field 212 for holding a unique identifier assigned to a medical consultant that conducted the particular diagnostic inquiry, a patient ID field 214 for holding a unique identifier of the patient, a timestamp field 216 for holding a value indicating data and time of an examination of the patient at which the inquiry was conducted, an inquiry ID field 218 for holding a unique identifier of the conducted inquiry, a result field 220 for holding a value indicating a result of the conducted inquiry, and a verification field 222 for holding a check digit generated for verifying a validity of any other number included in the first record set 201. The identification value held in any of the ID fields may comprise any suitable type of identifier. For example, the identifier held in practitioner ID field 212 may be the same number as or derived from a medical practitioner's national registration number and may also provide an indication of the medical practitioner's specialist qualifications and experience. As will be explained in greater detail below, each diagnostic inquiry for which a unique inquiry ID is provided may be included within a set of one or more diagnostic inquiries that is provided in association with a general symptom or diagnostic hypothesis, or a more specific diagnostic hypothesis.

The second code set format 202 is for storing information that is generated in association with first code sets regarding associations between particular medical conditions and corresponding diagnostic inquiries. As illustrated in FIG. 2b, each second code set includes four fields: an inquiry ID field 224 for holding the unique identifier of the diagnostic inquiry of the first code set with which the second code set is associated, a condition code field 226 for holding a unique identifier of a particular medical condition (for example, using a code provided according to the International Classification of Diseases (ICD)), an inquiry set ID field 228 identifying a set of diagnostic inquiries that could be conducted by a medical practitioner in relation to the diagnostic inquiry with respect to the particular medical condition, and a statistical weight field 230 for holding a value indicating a statistical weight for applying to a result of the diagnostic inquiry in a weighted assessment conducted with respect to the particular medical condition. For each first code set of information regarding a particular diagnostic inquiry that is stored in the electronic health record for a corresponding patient, there may be more than one second code set stored in the electronic health record in association with the first code set. Such a situation may arise, for instance, where a certain diagnostic inquiry is relevant to more than one particular medical condition related to a specified general symptom.

The third code set format 203 is for storing information that is generated in association with respective second code sets regarding information describing the associations between particular medical conditions and corresponding diagnostic inquiries. As illustrated in FIG. 2c, each third code set includes three fields: a condition code field 232 for holding the unique identifier of the particular medical condition of the respective second code set with which the second code set is associated, a description field 234 for holding a description of the corresponding diagnostic inquiry of the second code set in relation to the particular medical condition, and a reference field 236 for holding a reference to a publication containing a description of the corresponding diagnostic inquiry of the second code set in relation to the particular medical condition. The value held in reference field 236 can be, for example, a citation for a printed publication or hyperlink to a publication that is available on the internet.

The fourth code set format 204 is for storing financial information and treatment information for a corresponding patient that is generated in association with respective first and second code sets in regard to medical treatment services and products that are available to the patient for procuring in association a working diagnosis of a particular medical condition, which may have been selected by a medical practitioner based on the results of diagnostic inquiries conducted for a diagnostic hypothesis. As illustrated in FIG. 2d, each fourth code set includes four fields: a patient ID field 242 for holding a unique identifier of the corresponding patient, a budgeted item field 244 that holds a value associated with a particular treatment service or product (for example, a treatment code for a particular medical procedure or medication provided according to the Current Procedural Terminology (CPT) code set) for the particular medical condition selected as a working diagnosis, a budgeted cost field 246 that hold a value that is input manually or automatically generated to represent the cost of the particular treatment service or product associated with the value in the budgeted item field 244, and a funds availability field 248 that holds a value indicating whether an account associated with the patient has sufficient funds to pay for the cost of the particular treatment service or product indicated by the value in the budgeted cost field 246. The account associated with the patient can be, for example, a medical aid or bank account retained by the patient.

As will be explained in greater detail below, the value that is held in the funds availability field 248 may be generated, for example, based on an electronic query of an account associated with the patient that is performed to determine whether the account has sufficient funds to pay for the cost indicated by the value in the budgeted cost field 246. As will also be explained in greater detail below, for each working diagnosis of a particular medical condition that has been selected by a medical practitioner for a corresponding patient, there may be more than one fourth code set stored in the electronic health record in association with respective first and second code sets for the patient.

Referring again to illustrated in FIG. 1, examples of several services that may be provided through components of exemplary network system 100 will now be described with reference to the exemplary code set formats 201-204 illustrated in FIGS. 2a-2d. According to the client-server model of computer process interaction utilized in exemplary embodiments of the present invention described herein, a client process sends a message including a request to a server process, and the server process responds by providing a service. The server process may also return a message with a response to the client process. Often the client process and server process execute on different computer devices, called hosts, and communicate via a network using one or more protocols for network communications.

As used herein, the term “client” refers to the process that makes the request, or the host computer device on which the process operates. Similarly, as used herein, the term “server” refers to the process that provides the service, or the host computer device on which the process operates. In addition, a process executing as a server can be broken up to run as multiple servers on multiple hosts (sometimes called tiers) for reasons that include reliability, scalability, and redundancy, but not limited to those reasons.

As used herein, the terms “service,” “service task,” or the like can refer to any discrete, repeatable process used to encapsulate a functional unit of an application by providing an interface that is well-defined and implementation independent. The process can be an individual function or a collection of functions that together form a process. A service can be invoked (or consumed) by other services or client applications.

A service, such as a web service, may be implemented as a software application that may be called by another application to provide a service over a network, such as the Internet. A service represents a self-contained, self-describing piece of application functionality that can be found and called by other applications. A service may be self-contained because the application calling the service does not need to depend on anything other than the service itself, and may be self-describing because all the information on how to use the service can be obtained from the service itself. To interact with a service, a client system may make a call, such as a Simple Object Access Protocol (SOAP) call, to the service. The call may include sending a message, such as a SOAP message formatted in accordance with a WSDL (Web Services Definition Language) document describing the service.

In exemplary embodiments described below, each computing platform 110, 120, and 160a-160n is a user terminal or other client system or device implementing software for and running a respective client application for accessing services provided by web server 130 and/or local server 170. Such client applications may also be referred to as client modules, or simply clients, and may be implemented in a variety of ways. In exemplary embodiments, such client applications can be implemented as any of a myriad of suitable client application types, which range from proprietary client applications (thick clients) to web-based interfaces in which the user agent function is provided by a web server and/or a back-end program (for example, a CGI program).

For example, web server 130 can be configured to provide a web application for respective client applications implemented on patient platform 110 and practitioner platform 120 that provide web-based user interfaces for utilizing the services provided by web server 130. Likewise, local server 170 can be configured to provide a web application for respective client applications implemented on practitioner platforms 160a-160n that provide web-based user interfaces for utilizing the services provided by web server 170. For instance, the user interfaces of client applications implemented on patient platform 110 and practitioner platform 120 can be configured to provide various options corresponding to the functionality offered in exemplary embodiments described herein through suitable user interface controls (for example, by way of menu selection, point-and-click, dialog box, or keyboard command). In one general example, the user interfaces may provide “send” or “submit” buttons that allow users of client applications to transmit requested information to web server 130. The user interfaces can provide, for example, a common display structure that is rendered in a web browser as a web page representing services provided by web server 130 to a user of a client platform.

In exemplary system 100, as further illustrated in FIG. 1, web server 130 can be implemented to provide a profile generator service 132 and a patient management service 134 to client applications running on client platforms in communication with the web server over network 180. More specifically, profile generator service 132 is offered to provide for user registration with patient management service 134, and the patient management service is offered to provide for management of the care of patients that have registered with the patient management service.

In exemplary embodiments, web server 130 can be configured to maintain, host, and/or otherwise be in communication with a user account for each user that registers with patient management service 134. A user account includes information related to a particular user, which may be, for example, a patient or a medical practitioner. Accordingly, a user account may be a program and/or data structure that tracks various user-related data. In exemplary embodiments, the user-related data for user accounts is stored within data store 142 and accessed via database server 140, which, as illustrated in FIG. 1, is in communication with web server 130 and local server 170. In alternative exemplary embodiments, only certain user-related data for user accounts may be stored within data store 142 and accessed via database server 140, while the remaining user-related data for user accounts may be stored on and accessed from one or more data stores that are operatively connected to web server 130 and employed to store information local to the web server. For example, for a patient user account, health- and medical-related data for the patient may be stored within data store 142 and accessed via database server 140, while general biographical information for the patient, login credentials for the patient, and information indicating permissions that have been granted by the patient for accessing the health- and medical-related data for the patient within data store 142 may be stored on and accessed from a data store that is operatively connected and local to web server 130.

In a patient registration process, a patient profile is created for a patient and a corresponding electronic health record for the patient established within central data store 142. For example, a user operating patient platform 110 may use a patient client module 112 to initiate a registration session with profile generator 132 to that register with patient management service 134 and establish an electronic health record for a patient. During this patient registration session, patient client 112 will prompt the user to enter, via a user interface implemented on patient platform 110, background information about the patient such as name, address, age, gender, medical history, family history, lifestyle information, known drug allergies, and health insurance and/or bank account information, as well as login information and any other information that may be relevant to identifying and providing medical care to the patient. The background information entered by the user will then be converted to a suitable data format and transmitted by patient client 112 over network 180 to profile generator 132, which can then access data store 142 to create a new health record for the patient by generating a patient ID for uniquely identifying the patient and storing the patient ID with the submitted background data in a patient profile portion of the health record. The created health record can be indexed within the data store 142 using the patient ID and/or biographical information entered for the patient during the registration process.

In a registration process for an individual medical practitioner, a user may use a practitioner client module 122 implemented on individual practitioner platform 120, for example, to initiate a registration session with profile generator 132 to register the practitioner with patient management service 134 and establish a practitioner profile for a practitioner within central data store 142. During this practitioner registration session, practitioner client 122 will prompt the user to enter, via a user interface implemented on practitioner platform 120, biographical and practice information for the practitioner, as well as login information that will be used by the practitioner to access the services provided by web server 130 and any other information that may be relevant or useful for these services. The information entered by the user will then be converted to a suitable data format and transmitted by practitioner client 122 over network 180 to profile generator 132, which can then access data store 142 to create a practitioner profile by generating a practitioner ID for uniquely identifying the practitioner and storing the practitioner ID in association with the submitted data. The created practitioner profile can be indexed within the data store 142 using the practitioner ID and/or the other information entered for the practitioner during the registration process. In exemplary embodiments, the submitted data that is stored in a practitioner profile can include financial account information for accounts used to receive payment for medical services conducted for patients being treated by the practitioner.

In a registration process for a medical practitioner at the medical facility implementing medical facility system 150, a practitioner profile is created and stored for the practitioner within a practitioner data store 176 of local server 170 that stores data regarding practitioners that are practicing at the medical facility. In exemplary embodiments, practitioner data store 176 may be internal to local server 170 as illustrated in FIG. 1 or, alternatively, reside externally on a separate machine. In an example registration process, a user operating one of practitioner platforms 160a-160n may use a facility client module 162 implemented on the practitioner platform to initiate a practitioner registration session using a profile generator service 172 offered by local server 170, which is in communication with the facility client module via local network 152, to register the practitioner with facility system 150 and establish the practitioner profile. During this practitioner registration session, facility client 162 will prompt the user to enter, via a user interface implemented on practitioner platform 160, biographical and practice information for the practitioner, as well as login information that will be used by the practitioner to access the services provided by local server 170 and any other information that may be relevant or useful for these services. The information entered by the user will then be converted to a suitable data format and transmitted by facility client 162 over local network 152 to profile generator 172, which can then access practitioner data store 176 to create a practitioner profile by generating a practitioner ID for uniquely identifying the practitioner and storing the practitioner ID in association with the submitted data. The created practitioner profile can be indexed within practitioner data store 176 using the practitioner ID and/or the other information entered for the practitioner during the registration process.

In exemplary embodiments, local server 170 may, as illustrated in FIG. 1, be configured to communicate with database server 140 over network 180 to allow for the practitioner profiles stored in practitioner data store 176 to be synchronized with practitioner profiles for the same practitioners stored within central data store 142. For example, upon receiving the profile data for a practitioner that is new to the medical facility, profile generator 172 may communicate with database server 140 to create and/or synchronize a corresponding practitioner profile for the practitioner stored in data store 142 in conjunction with a creating the practitioner profile in practitioner data store 176.

It should of course be noted that registrations of patients and medical practitioners within system 100 are not limited to the particular sets of operations described above. For example, a medical practitioner may, during an initial visit from a patient, use practitioner client module 122 on individual practitioner platform 120 to initiate a patient registration session with profile generator 132 over network 180 to register the patient with patient management service 134 and create an electronic health record for the patient using background information provided by the patient during the visit, as well as any appropriate information on the patient received from other sources (for example, medical history information accumulated by other medical practitioners and authorized for release by the patient). The background information entered by the medical practitioner will then be converted to a suitable data format and transmitted by practitioner client 122 over network 180 to profile generator 132, which can then access data store 142 to create a new health record for the patient in the manner described above.

In another alternative example, a medical practitioner at the medical facility implementing medical facility system 150 may, during an initial visit from a patient, operate one of practitioner platforms 160a-160n to initiate a patient registration session using profile generator service 172 to register the patient with facility system 150 and establish an electronic health record for the patient within a patient data store 178 of local server 170 that stores patient-indexed electronic health records for patients visiting the medical facility. Patient data store 178 may be internal to local server 170 as illustrated in FIG. 1 or, alternatively, reside externally on a separate machine. More particularly, the medical practitioner can use facility client module 162 that is implemented on practitioner platform 160 to create an electronic health record for the patient using background information received for the patient during the visit. The background information entered by the medical practitioner will then be converted to a suitable data format and transmitted by facility client 162 over network 170 to profile generator 172, which can then access patient data store 178 to create the new health record for the patient by storing a patient ID uniquely identifying the patient with the submitted background data in a patient profile portion of the health record. The created health record can be indexed within patient data store 178 using the patient ID and/or biographical information entered for the patient during the registration process.

In exemplary embodiments, local server 170 may be further configured to communicate with database server 140 over network 180 to allow for the electronic health records stored in patient data store 178 for patients visiting the medical facility to be synchronized with electronic health records for the same patients stored within central data store 142 for patients that are registered with patient management service 134. For example, upon receiving the background data for a new patient of the medical facility, profile generator 172 can communicate with database server 140 to synchronize a corresponding health record for the patient stored in data store 142 in conjunction with a creating the health record for the patient in patient data store 178. Local server 170 may also be configured in exemplary embodiment to communicate with profile generator 132 over network 180 to create corresponding electronic health records for patients that have been registered with facility system 150 but not previously with patient management service 134, thereby registering the patients with patient management service 134. Likewise, local server 170 may also be configured to communicate with profile generator over network 180 to create practitioner profiles for practitioners that have been registered with facility system 150 but not previously with patient management service 134, thereby registering these practitioners with patient management service 134.

It should also be noted that, in exemplary embodiments, the types of user accounts that may be registered with patient management service 134 are not limited to accounts for patients and medical practitioners. For example, patient management service 134 may also be implemented to provide for registration of individuals involved in patient care such as nurses, physical therapists, and other caregivers and entities involved in patient care such as medical facilities, pharmacies, and health insurance companies. For such individuals and entities that register with patient management service 134 and access web server 130 using a client application with the registered account, patient management service 134 can be configured to provide a respective subset of the services provided to medical practitioners that is appropriate for each type of account. In exemplary embodiments, the particular client applications that are utilized for accessing patient management service 134 can be respective to and customized for each type of user account. For example, the particular client application that is utilized for each type of account can be implemented to a provide virtual computing platform that is specific to the services offered by that type of account.

Because the health and medical records of patients are highly confidential, exemplary system 100 can be implemented to provide for a high-level of security for information transferred between client applications implemented on patient and practitioner platforms and web server 130 and local server 170, as well as for access of patient electronic health record data that is maintained by web server 130 and local server 170. For example, for conducting secure communications between the patient and practitioner platforms and web server 130, the respective client applications can be configured to implement encryption/decryption services on the patient and practitioner platforms, and corresponding encryption/decryption services can be implemented at web server 130, typically using a well-known encryption/decryption package, such as “BLOWFISH” or “DES.” In this manner, all data transfers between the client applications and web server 130 can be encrypted/decrypted, for example, through an internet secure sockets layer connection. Such encryption/decryption services can be utilized for preventing theft or inadvertent loss of patient health and medical data. Local server 170 and database server 140 can also be configured to implement encryption/decryption services for communications therewith. Moreover, for securing access to patient electronic health record data that is maintained by web server 130 and local server 170, web server 130 and local server 170 can each be configured to implement certification and login mechanisms for verifying user attempting to access electronic health record data, as well permission/authorization mechanisms for allowing access to the electronic health record data for a patient to be controlled by the patient.

As noted above, web server 130 is implemented to offer a patient management service 134 that is provided to users via client applications running on client platforms in communication with the web server over network 180 for managing the care of patients for which electronic health records have been established in data store 142. An exemplary embodiment of patient management service 134 is illustrated in FIG. 3. As illustrated in FIG. 3, patient management service 134 includes a preliminary diagnostic component 310, a professional diagnostic component 320, and a treatment management component 330. The services offered by web server 130 through components 310-330 of patient management service 134 will now described in greater detail.

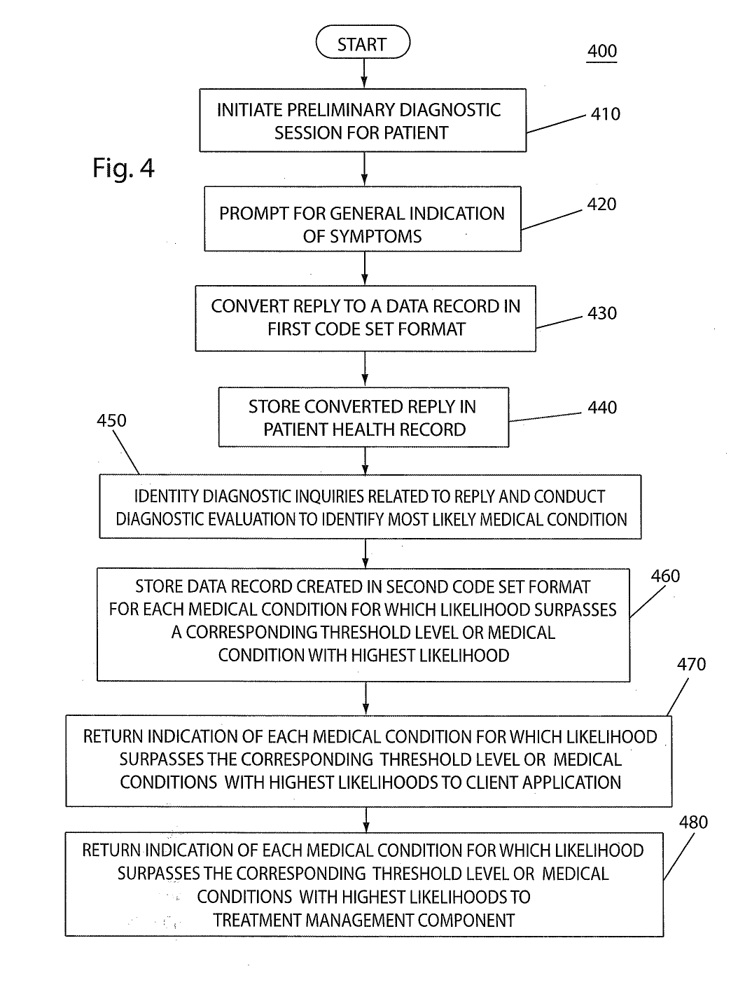

Referring now to FIG. 4, an exemplary embodiment of a process 400 for conducting a preliminary diagnostic session via preliminary diagnostic component 310 is illustrated. The preliminary diagnostic component 310 is configured to generate one or more preliminary diagnoses of a medical condition upon receiving general information describing symptoms being experienced by a patient. This information can be submitted, in a typical example, by a patient accessing management service 134 using patient client 112 over network 180. In exemplary process 400, at block 410, a preliminary diagnostic session with preliminary diagnostic component 310 is initiated by a user operating a client application running on a client platforms in communication with web server 130. For example, a patient operating patient platform 110 may use the user interface implemented by patient client 112 to submit login information to web server 130 associated with the health record for the patient in data store 142 and then select an option that is presented by the user interface for having the preliminary diagnostic session conducted for the patient using the patient client module.

At block 420, upon the session being initiated, the user is prompted by the client application with an initial inquiry to enter a general indication regarding the symptoms being experienced by the patient. For example, the patient can enter a general body region where pain or another problem is being experienced or the patient can enter a general symptom such as a headache. At block 430, the client application automatically converts the reply to the initial inquiry into a data record in first code set format 201, and the converted input from the user is transmitted over network 180 in the in first code set format to preliminary diagnostic component 310. For example, in the case of a patient submitting the general symptom of headache in reply to the initial inquiry, a data record can be created in first code set format 201 in which a null or default value is entered in practitioner ID field 212, the patient ID of the health record for the patient is entered in patient ID field 214, the time at which the reply was submitted is entered in timestamp field 216, an identifier of the initial inquiry is entered in inquiry ID field 218, and a value indicating the general headache symptom is entered in result field 220.

At block 440, preliminary diagnostic component 310 accesses database server 140 to store the converted reply in the health record for the patient in data store 142. At block 450, preliminary diagnostic component 310 identifies a set of one or more diagnostic inquiries that are related to the reply submitted for the initial general symptom inquiry and conducts a diagnosis evaluation to identify a most likely medical condition of patient by sequentially transferring inquiries from the identified set of diagnostic inquiries to the client application and receiving replies to the inquires submitted by the user through the user interface of the client application. More specifically, the client application, upon receiving each diagnostic inquiry from preliminary diagnostic component 310, prompts the user to input an answer to the diagnostic inquiry and, upon receiving the answer submitted by the user, formats the reply into data in first code set format 201, and transfers the converted input from the user over network 180 in the first code set format to preliminary diagnostic component 310. Upon receiving the converted reply data for each inquiry from the identified set of diagnostic inquiries present to the user via the client application, preliminary diagnostic component 310 accesses database server 140 to store the converted reply in the health record for the patient in data store 142, and determines the next inquiry or a next subset of related inquiries from the identified set of diagnostic inquiries to be sequentially provided to the user based on an analysis of the set of replies that have been received for the inquiries that have already been provided.

That is, the particular inquiries of the identified set of diagnostic inquiries for the initial general symptom inquiry that are actually provided and the order of these inquiries is dynamically determined by preliminary diagnostic component 310 based on the corresponding replies received for the inquiries. For example, during the diagnosis evaluation conducted at block 450, the analysis of the set of replies that have been received for the inquiries that have already been provided can lead to subsequent inquiries being selected from the identified set of diagnostic inquiries to be sequentially provided to the user that are at a higher level of sensitivity and/or specificity than the inquiries that have already been conducted. In exemplary embodiments, the set of diagnostic inquiries can include subjective inquiries that involve acquiring information (for example, information regarding clinical symptoms or medical history) by presenting the patient with a question and objective inquiries that involve obtaining information pertaining to clinical signs by directing the patient to perform a physical examination. In such embodiments, preliminary diagnostic component 310 can be configured to, when conducting the analysis conducted for dynamically determining the inquiries from the identified set of diagnostic inquiries to be sequentially provided to user based on an analysis of the set of replies that have been received, determine that a particular group of objective inquiries should be provided to the user based on an analysis of the replies received for a group of subjective inquiries that have already been provided.

During the diagnosis evaluation conducted at block 450, preliminary diagnostic component 310, in addition to analyzing the set of replies that have been received for the inquiries that have already been provided to dynamically determine the particular inquiries that are to be provided next, also performs an analysis of the set of replies that have been received to determine a likelihood for each of a plurality of particular medical conditions that are related to the reply submitted to the initial inquiry. In exemplary embodiments, the analysis of received replies that is conducted to determine the next diagnostic inquiry or the next subset of inquiries to be sequentially provided and the analysis of received replies that is conducted to determine the likelihood for each of the medical conditions that are related to the reply submitted to the initial general inquiry for the preliminary diagnostic evaluation may each be conducted by preliminary diagnosis component 310 according to a corresponding predetermined logical and/or computational model. For this purpose, preliminary diagnosis component 310 can be implemented to employ any suitable rules-based logical reasoning mechanisms, or combinations thereof, such as a many-valued logic algorithm or a probabilistic logic mathematical model (for example, a fuzzy logic model). In exemplary embodiments, the information that is utilized preliminary diagnostic component 310 in performing the preliminary diagnostic evaluation may be stored within data store 142 and accessed via database server 140 or, alternatively, stored on and accessed from one or more data stores that are operatively connected to web server 130 and employed to store information local to the web server.

In exemplary embodiments, for each reply that is received for a diagnostic inquiry, preliminary diagnostic component 310 also creates a data record in the second code set format 202 for each of the plurality of related medical conditions. For example, in the case of a patient submitting the general symptom of headache in reply to the initial inquiry, a particular medical condition of tension headache may be included within the plurality of related medical conditions. Then, upon receiving a reply to a diagnostic inquiry regarding a specific head region where pain is being felt, preliminary diagnostic component 310 creates a data record in the second code set format 202 in which an identifier of the diagnostic inquiry regarding a specific head region is entered in inquiry ID field 224, an identifier of the medical condition of tension headache is entered in condition code field 226, an identifier of a set of one or more specific diagnostic inquiries that could be conducted by a medical practitioner in relation to the specific head region with respect to the medical condition of tension headache can be entered in inquiry set ID field 228, and value indicating a statistical weight that is based on the answer provided by the patient to the diagnostic inquiry that is used a weighted assessment for determining the likelihood of tension headache being the medical condition of the patient can be entered in statistical weight field 230. Each of the data records created by preliminary diagnostic component 310 in second code set format 202 for a related medical condition may be temporarily stored locally at web server 130 during the diagnosis evaluation conducted at block 450.

In the present exemplary embodiment, preliminary diagnostic component 310 may also, during the analysis that is conducted at block 450 to determine the likelihood for each of the plurality of related medical conditions, determine at any point that the set of replies to diagnostic inquiries that have been received cannot correspond to certain medical conditions. Upon such a determination, preliminary diagnostic component 310 no longer includes those medical conditions in the analysis, determines to not provide any remaining inquiries from the identified set of inquiries that are specifically related to those medical conditions to the user during the diagnostic evaluation, and discards any of the data records that have been created in second code set format 202 for those medical conditions. The diagnostic evaluation conducted at block 450 continues until preliminary diagnostic component 310 determines, based on an analysis of the set of replies that have been received, that there are not any remaining inquiries from the identified set of diagnostic inquiries that should be provided to user or that the likelihood for at least one of the related medical conditions surpasses a corresponding threshold level for making a preliminary diagnosis of the medical condition, at which point the diagnostic evaluation is completed.

At block 460, upon the diagnostic evaluation being completed as described above, preliminary diagnostic component 310 accesses data server 140 to store, in the health record for the patient in data store 142, the data records created in second code set format 202 for each particular medical condition of which the likelihood has been determined to surpass the corresponding threshold level or, in the case in which the diagnostic evaluation has completed because there are no more inquiries remaining from the identified set of diagnostic inquiries that should be provided to user, the medical condition of the plurality of related medical conditions that is determined to have the highest likelihood based on the analysis of the set of replies that have been received. In exemplary embodiments, preliminary diagnostic component 310 may also be configured to access data server 140 to store, in the health record for the patient in data store 142, the data records created in second code set format 202 for each particular medical condition of the plurality of medical conditions to which the set of replies received for the diagnostic inquiries may still correspond. In further exemplary embodiments, preliminary diagnostic component 310 may also be configured to generate a respective data record in third code set format 203 corresponding to any of the data records created in second code set format 202 and stored in data store 142, and accesses data server 140 to store, in the health record for the patient in data store 142, the data record created in the third code set format. The data entered in reference field 236 of such a data record in third code set format 203 may be automatically entered by preliminary diagnostic component based on information that is maintained or otherwise accessible by web server 130.

In addition, also upon completion of the diagnostic evaluation, preliminary diagnostic component 310 returns to the client application, at block 470, an indication of the medical condition of which the likelihood has been determined to surpass the corresponding threshold level. Alternatively, at block 470, preliminary diagnostic component 310 may return an indication to the client application of one or more probable medical conditions of the plurality of related medical conditions that are determined to have the highest likelihoods based on the analysis of the set of replies that have been received (for instance, in the case in which the diagnostic evaluation has completed because there are no more inquiries remaining from the identified set of diagnostic inquiries that should be provided to user, or in the case in which the likelihood for more than one of the related medical conditions surpasses the corresponding threshold level the medical condition following the reply to the same diagnostic inquiry). Upon receiving this indication, the client application may provide an output of the indication transmitted at block 470 to the user. Finally, at block 480, preliminary diagnostic component 310 also provides an indication of the one or more probable medical conditions returned at block 470 to treatment management component 330.

In exemplary embodiments of the present invention, treatment management component 330 may be implemented to, upon receiving the indication of the one or more probable medical conditions from preliminary diagnostic component 310 at block 480 as described above, provide, via the user interface, relevant information pertaining to the indicated medical condition(s) such as, for example, citations of a printed publications or hyperlinks to informative or interactive websites and services that are available on the internet.

Treatment management component 330 may also be implemented to, upon receiving the indication of the one or more probable medical conditions from preliminary diagnostic component 310 at block 480 as described above, identify and provide a list of one or more medical practitioners that are qualified for treating the indicated medical condition via the user interface of the client application along with contact information for the medical practitioners, which may be utilized for scheduling an appointment for the patient with one of the listed medical practitioners. Treatment management component 330 may generate the list of medical practitioners by accessing, for example, a service offered by web server 130 for searching medical practitioners using corresponding input parameters, a service offered by another service provider, such as an online search service offered by a health insurance provider for the patient identified in the patient profile information, or a combination or an aggregated set of suitable services.

Treatment management component 330 may also be implemented to provide, via the user interface, a set of user interface elements (for instance, a list of choices that may be selected through a menu element) for selecting and scheduling an appointment for the patient with one of the listed medical practitioners with respect to results of the preliminary diagnostic evaluation. Treatment management component 330 may provide this functionality by, for example, accessing a service with which the selectable medical practitioners are associated, which may be a service offered by web server 130 or offered by another service provider.

Upon an appointment being scheduled for the patient with a medical practitioner using this functionality, treatment management component 330 may be implemented to generate a data record corresponding to this appointment in fourth code set format 201 and transmit the formatted data record to patient management service 134 of web server 130. Patient management service 134 may then access database server 140 to store the formatted scheduling data in the health record for the patient in data store 142. For example, as the data for a scheduled appointment, the patient ID of the health record for the patient may be entered in patient ID field 242, a treatment code or other value associated with the type of appointment scheduled (or, alternatively, a null or default value for a general appointment type) may be entered in budgeted item field 244, a value indicating an estimated or published cost for the appointment (or, alternatively, a null or default value where information regarding the cost of the appointment is not available) may be entered in budgeted cost field 246, and a value indicating whether a health insurance plan that is held by the patient covers the type of appointment indicated by the value in budgeted item field 244 may be entered in funds availability field 248. In this example, the value that is entered in funds availability field 248 may be automatically generated based on an analysis of a health insurance plan that is described in the patient profile portion of the stored health record for the patient or by using information included in the patient profile to perform an electronic query of a service offered by the provider for the health insurance plan.

In exemplary embodiments, treatment management component 330 may also be implemented to provide, via the user interface of the client application, an indication to the user of which of the listed medical practitioners are registered with patient management service 134. If an appointment is scheduled by the patient with a medical practitioner that is registered with patient management service 134 using this functionality, treatment management component 330 may further be configured to provide an option to the user to submit authorization via the user interface of the client application for the medical practitioner to access the information in the health record stored for the patient in data store 142. In exemplary embodiments, the option provided by treatment management component 330 for the user to authorize a medical practitioner to access health record for a patient may be further configured to allow for the user to provide authorization for access to only a specified subset of the information stored in the health record (for example, where clinical records are considered to be more sensitive by the patient). The particular authorization information submitted for a patient by the user may be transmitted from the client application to web server 130 over network 180, which, upon receiving this information, may access database server 140 to direct the database server to store an indication of the particular authorization specified in data store 142 in association with the patient profile of the health record for the patient. Alternatively, or in addition to directing database serve 140 to store the specified authorization for a medical practitioner to access the information stored in the health record for the patient, web server 130 may direct the database server to store an indication of the particular authorization specified in data store 142 in association with the practitioner profile of the medical practitioner for which the authorization is being submitted.

Such an authorization may then be utilized by the authorized medical practitioner accessing web server 130 via practitioner client 122 or local server 170 via facility client 162 to, for example, review the patient profile information included in the health record, review the replies submitted the inquiries conducted during the preliminary diagnostic evaluation or during any other relevant diagnostic evaluations conducted for the patient using patient management service 134, and fill-out information of patient information and consent forms prior to the appointment for the convenience of the patient. Treatment management component 330 can be configured to present this information and provide related functionality to the practitioner via the user interface of the practitioner client based on the authorization for the practitioner specified by the patient.

As will be described in greater detail below, patient authorization for the medical practitioner to access the information in the health record stored for the patient in data store 142 may also be utilized by the authorized medical practitioner accessing web server 130 via practitioner client 122 or local server 170 via facility client 162 to update the information stored in the health record of the patient through use of the services provided by patient management service 134 during the appointment with patient. For example, treatment management component 330 can provide functionality via the user interface of the practitioner client for to the practitioner to, during the scheduled appointment, submit information used to create and edit data records in the fourth code set format for services performed by the practitioner during the appointment.

In exemplary embodiments, treatment management component 330 may be further implemented to support a collaborative platform such as a web-based Integrated Collaboration Environment (ICE) that may be utilized for various collaboration and communication purposes by patients accessing web server 130 via patient client 112, medical practitioners accessing web server 130 via practitioner client 122, and/or medical practitioners accessing local server 170 via practitioner client 162. Such a collaborative platform can be implemented in a distributed manner and integrated with patient management service 134 and/or patient management service 174 to provide an environment for a virtual team to engage in asynchronous and synchronous collaboration and communication by incorporating various types of collaborative software tools. A collaborative platform may support features such as email, calendaring and scheduling, application sharing, workflow systems, web-based conferencing, desktop videoconferencing, telephony, Voice over Internet Protocol (VoIP) technology, and instant messaging within a single collaborative environment. Through the features supported by a collaborative platform, each participant of a virtual team can operate a client system to access and interact with the other participants despite being in dispersed locations. In the present exemplary embodiment, such a collaborative platform can allow, for example, certain diagnostic evaluations to be conducted for patients by one or more practitioners in disparate locations (for instance, a preliminary diagnostic evaluation conducted by a practitioner using professional diagnostic component 320 as described below), as well as for multiple practitioners located in disparate locations to perform a collaborative review and evaluation of the progress of a patient being seen by each of the multiple practitioners with respect to a particular medical condition. The collaborative platform can also allow for the patient to be actively involved in this collaborative review and evaluation.

As noted above, in exemplary embodiments of the present invention, system 100 may further be implemented to offer services for utilization by medical practitioners that are registered with patient management service 134 during appointments with patients that are also registered with patient management service 134. More specifically, as illustrated in FIG. 1, these services may be offered by patient management service 134 to medical practitioners accessing web server 130 via practitioner client 122 or, for practices at the medical facility implementing medical facility system 150, by a patient management service 174 to medical practitioners accessing local server 170 via practitioner client 162. Examples of these services will now be discussed in terms of functionality provided by components of patient management service 134 for medical practitioners accessing web server 130 via practitioner client 122.

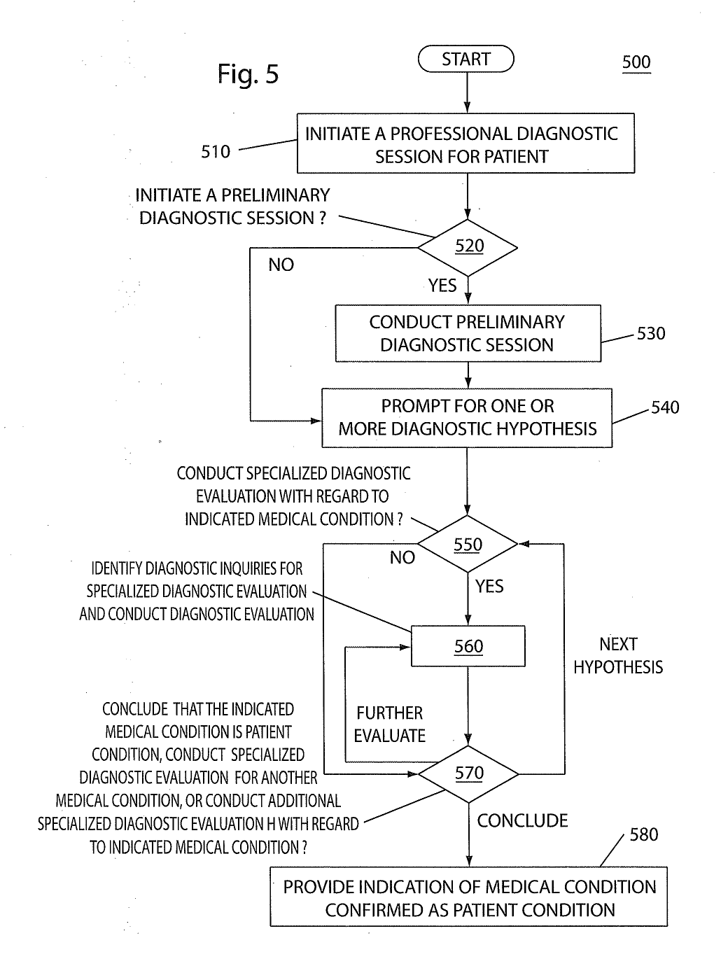

Referring now to FIG. 5, an exemplary embodiment of a process 500 for conducting a professional diagnostic examination using professional diagnostic component 320 is illustrated. Professional diagnostic component 320 is configured to provide and receive replies to diagnostic inquires for guiding a medical practitioner in conducting specialized medical investigations with regard to a working diagnosis for a patient or in reaching a conclusion of a medical condition as a working diagnosis for a patient upon receiving information describing symptoms being experienced by a patient and information describing the results of diagnostic tests conducted on the patient in relation to the particular symptoms being experienced. Professional diagnostic component 320 can be utilized by a medical practitioner during a diagnostic examination to dynamically guide the practitioner according to a standard best practice protocol in performing the appropriate inquiries and request appropriate investigations based on the information accumulated during the diagnostic process and to provide a mechanism for adequately document the information accumulated during the diagnostic examination of the patient. To submit replies to some inquiries provided during exemplary process 500, the practitioner may have to conduct simple tests or more complex investigations on the patient.

In a typical example, the information describing the replies to the inquiries provided during exemplary process 500 can be submitted by a practitioner accessing patient management service 134 using practitioner client 122 on practitioner platform 120 in communication with web server 170 over network 180 during an appointment with a patient that is registered with patient management service 134. At the outset of the appointment, at block 510 of exemplary process 500, the medical practitioner may direct practitioner client 122 to access patient management service 134 to initiate a professional diagnostic session with professional diagnostic component 330. This operation may involve, for example, the practitioner using practitioner client 122 to login to the web server 170 according to the login credentials stored in the practitioner profile for the practitioner and then submitting information identifying the patient with whom the appointment is being conducted.

At decision block 520, upon the session being initiated, the practitioner is provided with an option by practitioner client 122 to initiate a preliminary diagnostic session. The practitioner may elect to have a preliminary diagnostic session conducted, for example, in situations where such a session was not first conducted by the patient or where the practitioner wishes to confirm or conduct further evaluations regarding the results of a preliminary diagnostic session that was first conducted for the patient, for example, according to exemplary process 400 described above. The practitioner may decline the option to have a preliminary diagnostic session conducted, for example, in situations where the practitioner has reviewed and is satisfied with the results a preliminary diagnostic session that was first conducted for the patient or where the patient has been referred to the practitioner in regard to a conclusion of a working diagnosis of medical condition that has already been reached for a patient.

If the practitioner declines the preliminary diagnostic session, process 500 proceeds to block 540. If the practitioner elects to have the preliminary diagnostic session conducted, process 500 proceeds to block 530, at which the preliminary diagnostic session is conducted. In this example, the preliminary diagnostic session may be conducted in a similar manner to exemplary process 400 illustrated in FIG. 4, with the user being the medical practitioner and with the practitioner ID of the practitioner profile for the practitioner being entered in practitioner ID field 212 in the data records that are created in first code set format 201. Accordingly, the additional description of the preliminary diagnostic session conducted at block 530 that follows will be provided in terms of differences between exemplary process 400 and the preliminary diagnostic session provided by professional diagnostic component 320 that may arise in various exemplary embodiments.

For instance, in a situation where a preliminary diagnostic session was conducted for the patient in a previous session using preliminary diagnostic component 310, the replies that were submitted by the patient during this previous session to diagnostic inquiries that are presented again in the session with professional diagnostic component 320 may be read from the health record for the patient in data store 142 and transmitted in first code set format 201 by web server 130 to practitioner platform 120 for presentation in conjunction with the corresponding diagnostic inquiry via the user interface of practitioner client 122. The practitioner can then be provided with an option to confirm the previous reply or to update the health record for the patient with a different reply for this inquiry, in which case practitioner client 122 will convert the updated into a data record in first code set format 201 and transmit the converted over network 180 in the first code set format to professional diagnostic component 320, which may then access database server 140 to update the reply stored in the health record for the patient in data store 142. In addition, professional diagnostic component 320 may be implemented to provide certain diagnostic inquiries during a preliminary diagnostic session with practitioner client 122 that are more specifically tailored to the specialized knowledge of and/or medical equipment available for use by the medical practitioner than the diagnostic inquiries that are provided by preliminary diagnostic component 310 during a preliminary diagnostic session with patient client 112.

As another example, professional diagnostic component 320 may also be configured to provide an option via the user interface of practitioner platform 122, for each data record that is created in second code set format 202 during the diagnosis evaluation, for the practitioner to conduct any of the more specific diagnostic inquiries that may be specified in inquiry set ID field 228 of the data record. Upon such an option being selected by the practitioner, professional diagnostic component 320 can be implemented to provide the set or more specific inquiries via the user interface of via practitioner client 122, which can then receive the replies to the inquiries input by the practitioner, convert the replies into data records in first code set format 201, and transmit the replies in the converted format over network 180 in the first code set format to professional diagnostic component 320. Professional diagnostic component 320 may then access database server 140 to store the converted replies in the health record for the patient in data store 142. Moreover, in exemplary embodiments, professional diagnostic component 320 may also be further configured to include the replies submitted to these more specific inquiries in the analysis of received replies that is conducted to determine the next diagnostic inquiry or the next subset of inquiries to be sequentially provided and to determine the likelihood for each of the medical conditions that are related to the reply submitted to the initial general inquiry for the preliminary diagnostic evaluation.

At the completion of the preliminary diagnostic evaluation at block 530, professional diagnostic component 320 returns a result the evaluation to practitioner client 122 and proceeds to block 540. The result that is returned may be, for example, an indication of one or more medical conditions for which the likelihood has been determined to surpass the corresponding threshold level or an indication of one or more particular medical conditions that are determined to have the highest likelihoods based on the analysis of the set of replies that have been received.

In exemplary process 500, at block 540, the practitioner is prompted by practitioner client 122 to enter one or more diagnostic hypotheses for the medical condition being experienced by the patient, and the reply that is submitted is transmitted to professional diagnostic component 320. The practitioner may elect to reply with a single diagnostic hypothesis, for example, where the patient has been referred to the practitioner in regard to a conclusion of a working diagnosis of medical condition that has already been reached for a patient or where the practitioner has reached a conclusion that only one medical condition that was returned based on the diagnostic evaluation conducted either at block 530 or previously according to exemplary process 400) is possible. The practitioner may elect to reply with more than one diagnostic hypotheses, for example, where the practitioner believes that further investigations are required with regard with more than one medical condition to identify which of these medical conditions is the particular condition being experienced by the patient. Upon the reply being received by professional diagnostic component 320, an indication of the medical condition for each diagnostic hypothesis submitted by the practitioner is added to a queue that is maintained at the web server 130 for the professional diagnostic examination being conducted.

Exemplary process 500 then proceeds to decision block 550, at which professional diagnostic component 320 removes the indication of one of the medical conditions from the queue, transmits the indication of the medical condition to practitioner client 122, and directs the practitioner client to prompt the practitioner as to whether the practitioner wishes to conduct a further, more specialized diagnostic evaluation with regard to the indicated medical condition, if such a more specialized evaluation is offered with regard to the indicated medical condition. The reply from the practitioner is then transmitted over network 180 to professional diagnostic component 320. If the practitioner declines the more specialized evaluation, process 500 proceeds to decision block 570. If the practitioner elects to have the more specialized evaluation conducted, process 500 proceeds to block 560.

In certain situations in which a practitioner elects to have the more specialized evaluation conducted, this evaluation may be required to be conducted by a medical practitioner with a background that is more specific to the indicated medical condition. In exemplary embodiments of the present invention, professional diagnostic component 320 may be implemented to provide an option for the practitioner to, where such a situation arises, terminate the professional diagnostic examination at this juncture or pause the examination and allow for the practitioner to resume the examination at a later time following a corresponding examination being conducted by a specialist. In exemplary embodiments, professional diagnostic component 320 may also be configured to provide an indication of the more specialized evaluation to treatment management component 330, which may then, in a manner similar to that described above with reference to the medical condition returned by exemplary process 400, identify and provide a list of one or more medical practitioners that are qualified for treating the indicated medical condition that can be utilized for scheduling an appointment for the patient with one of the listed specialist practitioners. In addition, where the patient schedules an appointment with a specialist practitioner that is registered with patient management service 134, professional diagnostic component 320 may also be implemented to provide an option for the specialist practitioner to access patient management service 134 and takeover or conduct this portion of the professional diagnostic examination being conducted.

Returning to exemplary process 500 illustrated in FIG. 5, professional diagnostic component 320, block 560, identifies a set of one or more diagnostic inquiries for a more specialized evaluation related to the indicated medical condition and directs the evaluation in manner similar to the evaluation conducted at block 450 by sequentially transferring inquiries from the identified set of diagnostic inquiries to the client application and receiving replies to the inquires submitted by the user through the user interface of the client application. More specifically, practitioner client 122, upon receiving each diagnostic inquiry from professional diagnostic component 320, prompts the practitioner to input a reply to the diagnostic inquiry and, upon receiving the reply, formats the reply into data in first code set format 201 and transfers the converted input from the user over network 180 in the first code set format to professional diagnostic component 320. Upon receiving the converted reply data for each inquiry from the identified set of diagnostic inquiries presented practitioner client 122, professional diagnostic component 320 accesses database server 140 to store the converted reply in the health record for the patient in data store 142, and determines the next inquiry or a next subset of related inquiries from the identified set of diagnostic inquiries to be sequentially provided to user based on an analysis of the set of replies that have been received for the inquiries that have already been provided.

During the diagnosis evaluation conducted at block 560, professional diagnostic component 320, in addition to analyzing the set of replies that have been received for the inquiries that have already been provided to dynamically determine the particular inquiries that are to be provided next, also performs an analysis of the set of replies that have been received to update the likelihood for the indicated medical condition (or, where a preliminary diagnostic evaluation has not been conducted, determine the likelihood of the indicated medical condition). Furthermore, for each reply that is received for a diagnostic inquiry, professional diagnostic component 320 creates a data record in the second code set format 202 for the indicated medical condition and accesses data server 140 to store, in the health record for the patient in data store 142, the data records created in the second code set format for the indicated medical condition. In exemplary embodiments, preliminary diagnostic component 310 may also be configured to generate a respective data record in third code set format 203 corresponding to any of the data records created in second code set format 202 and stored in data store 142, and accesses data server 140 to store, in the health record for the patient in data store 142, the data record created in the third code set format. The data entered in reference field 236 of such a data record in third code set format 203 may be automatically entered by professional diagnostic component 320 based on information that is maintained or otherwise accessible by web server 130 or may be entered in the data record based on information submitted by the practitioner to professional diagnostic component via practitioner client 122 (for example, the practitioner may enter a citation for a printed publication that provides verification of the particular evaluation conducted for the corresponding diagnostic inquiry in relation to the indicated medical condition or a detailed personal explanation of the evaluation conducted). The data entered in description field 234 of such a data record in third code set format 203 may be automatically entered, for example, based on information submitted by the practitioner to professional diagnostic component via practitioner client 122.

In exemplary embodiments, professional diagnostic component 320 may also be configured to provide an option via the user interface of practitioner platform 122, for each data record that is created in second code set format 202 during the diagnosis evaluation conducted at block 560, for the practitioner to conduct any of the more specific diagnostic inquiries that may be specified in inquiry set ID field 228 of the data record. Upon such an option being selected by the practitioner, professional diagnostic component 320 can be implemented to provide the set or more specific inquiries via the user interface of via practitioner client 122, which can then receive the replies to the inquiries input by the practitioner, convert the replies into data records in first code set format 201, and transmit the replies in the converted format over network 180 in the first code set format to professional diagnostic component 320. Professional diagnostic component 320 may then access database server 140 to store the converted replies in the health record for the patient in data store 142. Moreover, in exemplary embodiments, professional diagnostic component 320 may also be further configured to include the replies submitted to these more specific inquiries in the analysis of received replies that is conducted in the determination of the next diagnostic inquiry or the next subset of inquiries to be sequentially provided and in the determination of the likelihood for the indicated medical condition. In addition, professional diagnostic component 320 may also be implemented in exemplary embodiments to allow for the practitioner to remove any diagnostic hypotheses from or add any new diagnostic hypotheses to the queue maintained at web server 130 based on the results of the examination being conducted.

In exemplary embodiments, the analysis of received replies that is conducted to determine the next diagnostic inquiry or the next subset of inquiries to be sequentially provided and the analysis of received replies that is conducted to determine the likelihood for the indicated medical condition may each be conducted by professional diagnosis component 320 according to a corresponding predetermined logical model or algorithm. For this purpose, professional diagnosis component 320 can be implemented to employ any suitable rules-based logical reasoning mechanisms, or combinations thereof, such as a many-valued logic algorithm or a probabilistic logic mathematical model (for example, a fuzzy logic model). In exemplary embodiments, the information that is utilized professional diagnostic component 320 in performing the professional diagnostic evaluation may be stored within data store 142 and accessed via database server 140 or, alternatively, stored on and accessed from one or more data stores that are operatively connected to web server 130 and employed to store information local to the web server.

In the present exemplary embodiment, the diagnostic evaluation conducted at block 560 continues until professional diagnostic component 320 determines, based on an analysis of the set of replies that have been received, that there are not any remaining inquiries from the identified set of diagnostic inquiries that should be provided to user or that that the set of replies to diagnostic inquiries that have been received cannot correspond to the indicated medical condition. At this point, the diagnostic evaluation is completed, an indication of the result of the more specialized diagnostic evaluation is transmitted from professional diagnostic component 320 to practitioner client 122 and presented to the practitioner via the user interface of practitioner client 122, and process 500 proceeds to decision block 570.

At decision block 570, at which professional diagnostic component 320 directs practitioner client 122 to prompt the practitioner as to whether the practitioner wishes to conclude that the indicated medical condition is the condition being experienced by the patient as a first option, conduct a more specialized diagnostic evaluation with regard to another medical condition for which an indication thereof remains in the queue maintained by web server 130 for the examination in a second option (if any such indication remains in the queue), or conduct an additional specialized diagnostic evaluation with regard to the indicated medical condition for which an evaluation was previously conducted at block 560 in a third option (if such an evaluation was conducted and if another such specialized evaluation is offered with regard to the indicated medical condition). In exemplary embodiments, if multiple specialized evaluation are offered that may be conducted with regard to a particular medical condition, professional diagnostic component 320 can be implemented to sequentially present these evaluations to the practitioner during exemplary process 500 in order from investigations that are more generally relevant and/or basic to investigations that are more specific, advanced, and/or costly. The reply from the practitioner is then transmitted over network 180 to professional diagnostic component 320. If the practitioner selects the first option, process 500 proceeds to block 580, if the practitioner selects the second option, process 500 returns to block 550, and if the practitioner selects the third option, process 500 returns to block 560. Finally, upon exemplary process reaching block 580, professional diagnostic component 320 also provides an indication of the medical condition confirmed by the practitioner at block 570 as the condition being experienced by the patient to treatment management component 330.

In exemplary embodiments of the present invention, treatment management component 330 can be implemented to, upon receiving the indication of the medical condition confirmed by the practitioner as the condition being experienced by the patient from professional diagnostic component 320 at block 580 as described above, generate a care plan for the patient using the indicated medical condition as a working diagnosis. Treatment management component 330 can generate the care plan according to a best practice protocol for treating the indicated medical condition. In exemplary embodiments, certain aspects of the care plan for the patient can be determined and updated based on an analysis of particular results of the diagnostic evaluations conducted on the patient by accessing the information in the electronic health record stored for the patient within data store 142.

The generated care plan can comprise a set of medical treatment services available to the patient for treating the indicated medical condition along with a timeline for conducting the services and goals to be achieved by conducted the treatment services in accordance with the timeline. The set of treatment services can include, for example, procedures that may conducted on the patient by medical practitioners during the course of treatment for the indicated medical condition and medications that may be administered to the patient during the course of treatment for the indicated medical condition. In exemplary embodiments, treatment management component 330 may generate the care plan by accessing, for example, a service offered by web server 130, a service offered by another service provider, or a combination or an aggregated set of suitable services. In addition, information that is utilized treatment management component 330 in generating the care plan may be stored within data store 142 and accessed via database server 140 or, alternatively, stored on and accessed from one or more data stores that are operatively connected to web server 130 and employed to store information local to the web server.

Treatment management component 330 can be further implemented to access database server 140 store data describing the generated care plan in the electronic health record for the patient in data store 142 to allow for the patient and medical practitioners authorized by the patient that are registered with patient management service 134 to access, review, and update the care plan via network 180 using the client applications implemented on patient and practitioner platforms throughout the course of treatment for the patient. For example, for each of the medical treatment services in the generated care plan, treatment management component 330 can be implemented to generate a data record corresponding to the treatment service in fourth code set format 204 for storage in the electronic health record for the patient within data store 142. More specifically, in the data record generated for a treatment service, the patient ID of the health record for the patient may be entered in patient ID field 242, a treatment code or other value associated with the type of service may be entered in budgeted item field 244, a value indicating an estimated or published cost for the service (or, alternatively, a null or default value where information regarding the cost of the service is not available) may be entered in budgeted cost field 246, and a value indicating whether an account associated with the patient has sufficient funds to pay for the cost of the particular treatment service or product indicated by the value in the budgeted cost field 246 may be entered in funds availability field 248.

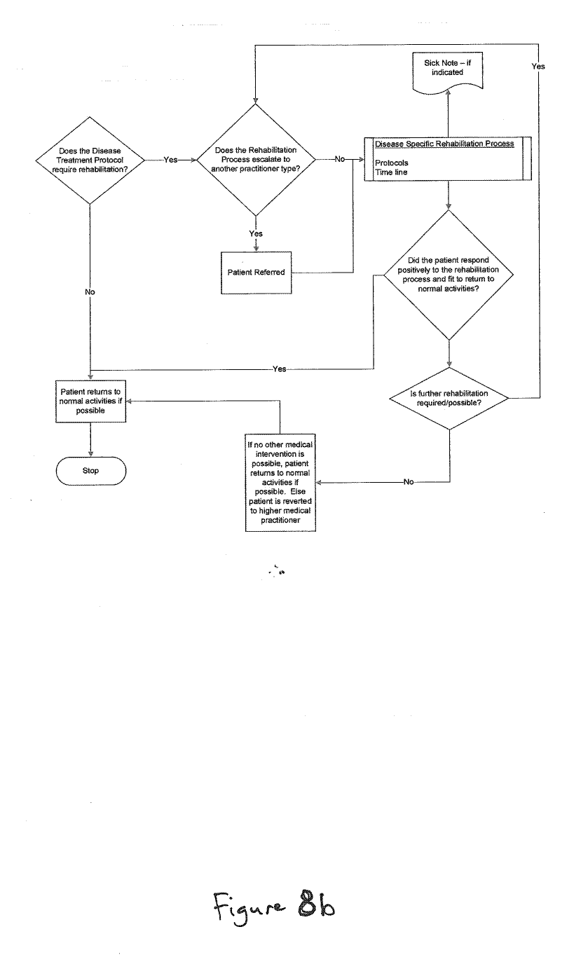

In exemplary embodiments, treatment management component 330 can be implemented to provide functionality for a medical practitioner accessing web server 130 via practitioner client 122 to monitor and respond to the progress of patient with regard to a care plan generated for the patient, receive guidance for monitoring and responding to the progress of patient with regard to a care plan generated for the patient in accordance with best care plan protocols, and provide specialist referrals, generate sick notes, and write prescriptions as needed or requested by the patient. In exemplary embodiments, treatment management component 330 can be implemented to provide functionality for a patient accessing web server 130 via patient client 112 to retrieve and print sick notes and prescriptions, schedule appointments in accordance with specialist referrals, forward prescriptions to pharmacies, and provide authorization for payment for a prescription forwarded to a pharmacy. FIGS. 8a and 8b are flowcharts illustrating a non-limiting example of a process 800 performed by treatment management component 330 to guide a medical practitioner in monitoring and responding to the progress of patient with regard to a care plan generated for the patient.

In exemplary embodiments, treatment management component 330 may be configured to, for a particular treatment service specified in a care plan, obtain information regarding estimated or published costs for the service from a plurality of service providers and generate a corresponding data record corresponding to the treatment service in fourth code set format 204 for storage in the electronic health record for the patient within data store 142 for each of the service providers. This information can be obtained by treatment management component 330, for example, by accessing database server 140 to receive cost information submitted by and maintained within data store 142 for practitioners and other entities registered with patient management service 134.

As noted above, the account associated with the patient in relation to the value entered in funds availability field 248 can be, for example, a medical aid or financial account retained by the patient. The value that is entered in funds availability field 248 may be automatically generated by treatment management component 330, for example, based on the result of an electronic query performed using a service offered by the servicer of a financial account that is described in the patient profile portion of the stored health record for the patient that is performed to determine whether the account has sufficient funds to pay for the cost indicated by the value in the budgeted cost field 246. In another example, the value that is entered in funds availability field 248 may be automatically generated by treatment management component 330 based on an analysis of a health insurance plan that is described in the patient profile portion of the stored health record for the patient or based on the result an electronic query performed using a service offered by the provider for the health insurance plan described in the patient profile.

In exemplary embodiments, treatment management component 330 can be further configured to provide, via the user interface of a client application accessing patient management service 134, an option to a patient for which a care plan has been generated, to select a particular treatment service outlined in the care plan for which the value in funds availability field 248 of the corresponding data record stored in data store 142 indicates that the account associated with the patient has sufficient funds or coverage for the cost of the treatment service and provide authorization for payment for the selected treatment service. Such an option can be provided, for example, for a service provided a medical practitioner that is registered with patient management service 134 and for which the data that is stored in the practitioner profile includes financial account information for an account used to receive payment for medical services. The patient may provide this authorization prior to or following the medical service being administered, and treatment management component 330 can be configured to, upon the authorization being provided by the patient, access an appropriate payment servicing system and utilize the account information stored for both patient and the practitioner in data store 142 to direct the payment servicing system to conduct the payment authorized by the patient by receiving the amount indicated in budgeted cost field 246 for the data record of the treatment service from the account servicer of the patient and crediting the account of the practitioner with this amount.

Referring again to FIG. 1, it should be noted that functionality similar to that provided by patient management service 134 to a medical practitioner operating practitioner platform 120 in the examples discussed above may also be provided by patient management service 174 to medical practitioners accessing local server 170 via practitioner client 162. For example, patient management service 174 may be implemented with components that are substantially the same as preliminary diagnostic component 310, professional diagnostic component 320, and treatment management component 330 in terms of the services offered to medical practitioners, except that the corresponding components of patient management service 174 may be configured to direct local server 170 to access and update the information of a health record for the patient being seen that is stored within patient data store 178 rather than within data store 142. In exemplary embodiments, patient management service 174 may further be configured to perform conversion of information received from practitioner client 162 into data records in code set formats 201-204. For example, in these embodiments, data for replies to diagnostic inquiries that are input to practitioner client 162 during exemplary process 500 illustrated in FIG. 5, rather than being converted into data records in first code set format 201 by the practitioner client, would be transmitted to local server 170 as unformatted data and then converted into data records in first code set format 201 prior to being stored within patient data store 178 in the health record for the patient being evaluated.

In addition, upon a medical practitioner using practitioner client 162 on practitioner platform 160 to initiate a session with patient management service 174 over local network 152 for an appointment with a patient, local server 170 may, as illustrated in FIG. 1, be configured to access database server 140 over network 180 to download the health record stored for the patient within data store 142 and use this information create, or synchronize the downloaded information with, a corresponding health record that is stored for the same patient within patient data store 178. Likewise, upon the session between practitioner client 162 and patient management service 174 being terminated at the end of the appointment, local server 170 may also be configured to access database server 140 over network 180 to synchronize the health record stored for the patient within data store 142 with the health record stored for the patient within patient data store 178 that has been updated during the appointment.

In exemplary embodiments of the present invention, web server 130 may also be configured to maintain records of all or certain transactions with client applications for future analysis. Such transaction data may be used, for instance, for the particular procedures, costs, and results for related clinicians that have followed the same best practice diagnostic or care plan protocols implemented by patient management service 134 to be compared, contrasted, and statistically evaluated. This transaction data may be stored within data store 142 and accessed by web server 130 via database server 140 or, alternatively, stored on and accessed from one or more data stores that are operatively connected to web server 130 and employed to store information local to the web server. In exemplary embodiments, data store 142 and/or data stores for storing information local to the web server may comprise multiple data stores or be partitioned into multiple data stores that each respectively store a particular type of data. In one non-limiting example, the types of data may be stored in divided fashion among separate data stores for practitioner profile data, patient profile data, patient health and medical data, individual and entity financial information, best practice diagnostic protocol data, diagnostic evaluation model data, best practice care plan protocol data, treatment analysis data, and transaction data.

In exemplary embodiments, the best practice diagnostic and care plan protocols utilized by patient management service 134 may be implemented in accordance with the standards of relevant governing medical bodies and medical organizations. Exemplary embodiments of the present invention can be implemented in accordance with HIPPA and HL-7 requirements.

Aspects of exemplary embodiments of the present invention described herein can be implemented using one or more program modules and data storage units. As used herein, the term “modules”, “program modules”, “components”, “systems”, “tools”, “utilities”, and the like include routines, programs, objects, components, data structures, and instructions, or instructions sets, and so forth that perform particular tasks or implement particular abstract data types. As can be appreciated, the modules refer to computer-related entities that can be implemented as software, hardware, firmware and/or other suitable components that provide the described functionality, and which may be loaded into memory of a machine embodying an exemplary embodiment of the present invention. Aspects of the modules may be written in a variety of programming languages, such as C, C++, Java, etc. The functionality provided by modules used for aspects of exemplary embodiments described herein can be combined and/or further partitioned.

As used herein, the terms “data storage unit,” “data store”, “storage unit”, and the like can refer to any suitable memory device that may be used for storing data, including manual files, machine readable files, and databases. The modules and/or storage units can all be implemented and run on the same computing system (for example, the exemplary computer system illustrated in FIG. 6 and described below) or they can be implemented and run on different computing systems. For example, one or modules can be implemented on a personal computer operated by a user while other modules can be implemented on a remote server and accessed via a network.

In exemplary embodiments, the client applications utilized in exemplary embodiments of the present invention can be configured for incorporation within any suitable network computing environment as a plug-in, add-on, or extension. As used herein, the term “plug-in” can refer to a software application or module program, or one or more computer instructions, which may or may not be in communication with other software applications or modules, that interacts with a host application to provide specified functionality, and which may include any file, image, graphic, icon, audio, video, or any other attachment. In other exemplary embodiments, the client applications can be implemented as a standalone program that is run as a separate computer process, a portable application, a native component of an automated software testing tool, a part of a software bundle, or any other suitable implementation.

In the preceding description, for purposes of explanation, numerous specific details are set forth in order to provide a thorough understanding of the described exemplary embodiments. Nevertheless, one skilled in the art will appreciate that many other embodiments may be practiced without these specific details and structural, logical, and electrical changes may be made.

Some portions of the exemplary embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: (a) conversion to another language, code or, notation; and (b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 6 is a block diagram of an exemplary computer system 600 that can be used for implementing exemplary embodiments of the present invention. Computer system 600 includes one or more processors, such as processor 604. Processor 604 is connected to a communication infrastructure 602 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 600 can include a display interface 608 that forwards graphics, text, and other data from the communication infrastructure 602 (or from a frame buffer not shown) for display on a display unit 610. Computer system 600 also includes a main memory 606, which can be random access memory (RAM), and may also include a secondary memory 612. Secondary memory 612 may include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, removable storage unit 618 includes a computer usable storage medium having stored therein computer software and/or data.

In exemplary embodiments, secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (that is, channel) 626. Channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface including a wired network or a wireless network that allow a computer to read such computer readable information.

Computer programs (also called computer control logic) are stored in main memory 606 and/or secondary memory 612. Computer programs may also be received via communications interface 624. Such computer programs, when executed, can enable the computer system to perform the features of exemplary embodiments of the present invention as discussed herein. In particular, the computer programs, when executed, enable processor 604 to perform the features of computer system 600. Accordingly, such computer programs represent controllers of the computer system.

While the invention has been described in detail with reference to exemplary embodiments, it will be understood by those skilled in the art that various changes and alternations may be made and equivalents may be substituted for elements thereof without departing from the scope of the invention as defined by the appended claims. In addition, many modifications may be made to adapt a particular application or material to the teachings of the invention without departing from the essential scope thereof.

Variations described for exemplary embodiments of the present invention can be realized in any combination desirable for each particular application. Thus particular limitations, and/or embodiment enhancements described herein, which may have particular limitations need be implemented in methods, systems, and/or apparatuses including one or more concepts describe with relation to exemplary embodiments of the present invention.

Therefore, it is intended that the invention not be limited to the particular embodiments disclosed as the best mode contemplated for carrying out this invention, but that the invention will include all embodiments falling within the scope of the present application as set forth in the following claims, wherein reference to an element in the singular, such as by use of the article “a” or “an” is not intended to mean “one and only one” unless specifically so stated, but rather “one or more.” Moreover, no claim element is to be construed under the provisions of 35 U.S.C. §112, sixth paragraph, unless the element is expressly recited using the phrase “means for” or “step for.” These following claims should be construed to maintain the proper protection for the present invention.

What is claimed is:

1. A method of performing a diagnosis by acquiring data, the method comprising:
receiving one or more indications of a diagnostic hypothesis regarding a subject and adding each indication to a queue upon the indication being received;
sequentially removing each indication from the queue and processing the indication by:
sequentially outputting questions of a structured set of questions related to the diagnostic hypothesis for the indication;
receiving a reply corresponding to each question of the set of questions that is output; and
for each question of the set of questions that is output, generating a respective set of data pertaining to the question and the corresponding reply for the question and formatting the respective set of data into a plurality of record sets for the question; and
storing the plurality of record sets for each question within a database in an entry associated with the subject and the diagnostic hypothesis to which the question is related, and
wherein the plurality of record sets for each question includes first, second, and third record sets,
wherein the first record set for each question includes a first unique number associated with the subject, a second unique number associated with a person making the diagnostic hypothesis to which the question is related, a third unique number associated with the question, and a fourth number generated based on the corresponding reply for the question;
wherein the second record set for each question is generated in association with the first record set for the question, and the second record set includes a question code associated with the third unique number of the first record set for the question; and a statistical weight associated with the third unique number of the first record set for the question for applying to the fourth number of the first record set for the question;
wherein the third record set for each question is generated in association with the second record set for the question, the third record set including a description reference of the question code of the second record set for the question; and
wherein the questions of the structured set of questions for each indication are dynamically selected for outputting based on the corresponding replies received for the questions.

2. A method as claimed in claim 1, wherein the plurality of record sets for each question further includes a fourth record set identifying financial data, wherein the fourth record set is associated the diagnostic hypothesis to which the question is related and includes a budgeted item number, a budgeted value, and a funds availability number, wherein the budgeted item number is associated with an analysis of the corresponding replies for the questions of the structured set of questions related to the diagnostic hypothesis that are output, wherein the budgeted value is input manually or automatically generated based on the budgeted item number, and further comprising, for each fourth record set associated a diagnostic hypothesis, performing an electronic query of an account associated with the subject to determine whether the account has sufficient funds for the budgeted value and generating the funds availability number based on the electronic query of the account.

3. A method as claimed in claim 1, wherein, for each question, the person making the diagnostic hypothesis to which the question is related is a medical practitioner.

4. A method as claimed in claim 3, wherein, for each question, the second unique number is associated with a national registration number of the medical practitioner for the question.

5. A method as claimed in claim 3, wherein, for each question, the second unique number is based on specialist qualifications and experience of the medical practitioner for the question.

6. A method as claimed in claim 1, wherein the subject is a medical patient.

7. A method as claimed in claim 1, wherein, for each question, the fourth number is generated to indicate a true or false answer.

8. A method as claimed in claim 1, wherein, for each question, the first record set further includes a fifth number associated with a date and time of an examination of the subject during which the corresponding reply for the question was received.

9. A method as claimed in claim 1, wherein, for each question, the first record set includes a sixth number generated as a check digit for verifying a validity of any other number included in the first record set.

10. A method as claimed in claim 1, wherein, for each question, the second record set further includes a list of unique numbers associated with questions that could be asked in relation to the question for the second record set.

11. A method as claimed in claim 10, wherein, for each question, each unique number of the list of third numbers is associated with at least one further question which should be answered.

12. A method as claimed in claim 1, wherein, for each question, the third record set includes a reference to a publication containing a description of the question code of the second record set for the question.

13. A method as claimed in claim 2, wherein, for each question, the budgeted item number of the fourth record set associated with the diagnostic hypothesis to which the question is related indicates a type of treatment or medication required by the subject.

14. A method as claimed in claim 13, wherein, for each question, the budgeted value of the fourth record set associated with the diagnostic hypothesis to which the question is related is a cost associated with the type of treatment or medication indicated by budgeted item of the fourth record set.

15. A method as claimed in claim 2, wherein, for each fourth record set, the account is a medical aid or bank account for the subject.
